(19) United States
(12) Patent Application Publication
(10) Pub. No.: US 2011/0224896 A1
(43) Pub. Date: Sep. 15, 2011

(54) METHOD AND APPARATUS FOR PROVIDING TOUCH BASED ROUTING SERVICES

(75) Inventor: André Napieraj, Smorum (DK)

(73) Assignee: Nokia Corporation

(21) Appl. No.: 12/720,283

(22) Filed: Mar. 9, 2010

(51) Int. Cl. G01C 21/00; G06F 3/01; G06F 3/048

(52) U.S. Cl. 701/200; 715/702; 715/781

(57) ABSTRACT

A method for providing touch based routing services may include receiving an indication of a first touch event defining a start point on a map displayed on a touch screen display, receiving an indication of a second touch event defining a destination point on the map while the first touch event is maintained, and generating a route between the start point and the destination point for display on the touch screen display. A corresponding computer program product and apparatus are also provided.

### TECHNOLOGICAL FIELD

Embodiments of the present invention relate generally to map services technology and, more particularly, relate to a method, apparatus and computer program product for providing multi-touch based routing services.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or request made by the user (e.g., content searching, mapping or routing services, etc.). The services may be provided from a network server or other network device, or even from the mobile terminal such as, for example, a mobile telephone, a mobile navigation system, a mobile computer, a mobile television, a mobile gaming system, etc.

Due to the ubiquitous nature of mobile electronic devices, people of all ages and education levels are now utilizing mobile terminals to communicate with other individuals or contacts, receive services and/or to share information, media and other content. Additionally, given recent advances in processing power, battery life, the availability of peripherals such as global positioning system (GPS) receivers and the development of various applications, mobile electronic devices are increasingly used by individuals for receiving mapping or navigation services in a mobile environment. For example, cellular telephones and other mobile communication devices may be equipped with GPS and may be able to provide routing services based on existing map information and GPS data indicative of the location of the cellular telephone or mobile communication device of a user.

Despite the great utility of enabling mobile users to utilize mapping or navigation services, the ability of a user to interface with those services is still of great importance. In this regard, the manner in which the user interfaces with the services may impact the user's ability to effectively utilize service capabilities and also impact the user's experience and thereby also influence the likelihood that the user will continue to regularly make use of the service. Accordingly, it may be desirable to continue to provide improvements to the interface between users and the services their respective devices may be capable of providing.

### BRIEF SUMMARY

A method, apparatus and computer program product are therefore provided to enable users to perform route calculation and manipulation with a multi-touch interface. Accordingly, for example, the user may use multiple fingers on a touch display to define a route start point and end point and also define waypoints along the route with corresponding touch events (e.g., using finger touches). Moreover, the user may be enabled to add or change the waypoints or even the start or end points by moving the fingers that correlate to each respective point in order to dynamically adjust route calculation.

In one example embodiment, a method of providing multi-touch based routing services is provided. The method may include receiving an indication of a first touch event defining a start point on a map displayed on a touch screen display, receiving an indication of a second touch event defining a destination point on the map while the first touch event is maintained, and generating a route between the start point and the destination point for display on the touch screen display.

In another example embodiment, a computer program product for providing multi-touch based routing services is provided. The computer program product includes at least one computer-readable storage medium having computer-executable program code instructions stored therein. The computer-executable program code instructions may include program code instructions for receiving an indication of a first touch event defining a start point on a map displayed on a touch screen display, receiving an indication of a second touch event defining a destination point on the map while the first touch event is maintained, and generating a route between the start point and the destination point for display on the touch screen display.

In another example embodiment, an apparatus for providing multi-touch based routing services is provided. The apparatus may include at least one processor and at least one memory including computer program code. The at least one memory and the computer program code may be configured to, with the at least one processor, cause the apparatus to perform at least receiving an indication of a first touch event defining a start point on a map displayed on a touch screen display, receiving an indication of a second touch event defining a destination point on the map while the first touch event is maintained, and generating a route between the start point and the destination point for display on the touch screen display.

Embodiments of the invention may provide a method, apparatus and computer program product for employment in mobile environments in which mapping or routing services are provided. As a result, for example, mobile terminal users may enjoy an improved mapping or routing service on the basis of maps that provide the user with multi-touch based capability to define route parameters.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 is a schematic block diagram of a wireless communications system according to an example embodiment of the present invention;

FIG. 2 illustrates a block diagram of an apparatus for providing touch based routing services according to an example embodiment of the present invention;

FIG. 3 (which includes FIGS. 3A to 3G) illustrates an example of a map display during various stages of operation according to an example embodiment of the present invention; and

FIG. 4 is a flowchart according to another example method for providing touch based routing services according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the provision of dynamic route calculation via multiple touch inputs. The route may then be dynamically adjusted by moving fingers over a multi-touch panel. As such, embodiments of the present invention may be practiced on multi-touch screen displays (e.g., touch screen displays that are capable of recognizing and responding to more than two touches as opposed to a single or dual touch display which can only respond to one or two touches, respectively). Accordingly, although touch displays may be generally referenced herein, it should be understood that example embodiments relate to multi-touch displays so that the multiple touches described in connection with example embodiments may be handled appropriately. In some cases, example embodiments may be employed to enable a user to touch a first portion of a touch screen displaying map data to define a start point for a route and also touch a second portion of the touch screen to define a destination point for the route. The touch events may typically be initiated with a user's fingers, but any pointing device could be employed. A route may then be calculated between the start point and the destination point and displayed with respect to the map data. In some embodiments, a third touch event (or even fourth and beyond) may define a waypoint (or multiple waypoints) through which the route between the start point and destination point should travel. The route may then be dynamically adjusted to pass through the defined waypoint(s). Example embodiments may therefore provide for a relatively easy and intuitive mechanism by which a user may define and manipulate route data using one hand (or even both hands if a large number of waypoints are desired).

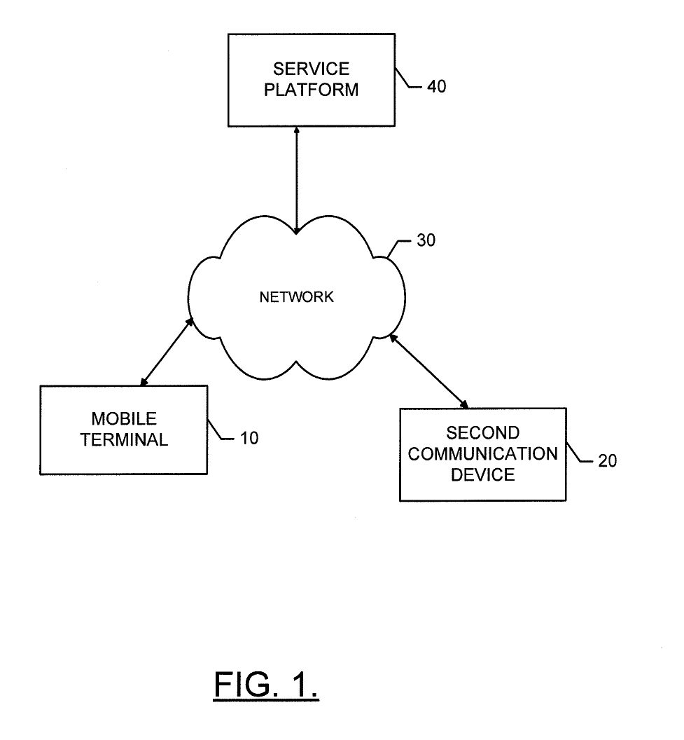

FIG. 1 illustrates a generic system diagram in which a device such as a mobile terminal 10, which may benefit from embodiments of the present invention, is shown in an example communication environment. As shown in FIG. 1, a system in accordance with an example embodiment of the present invention includes a first communication device (e.g., mobile terminal 10) and a second communication device 20 that may each be capable of communication with a network 30. The second communication device 20 is provided as an example to illustrate potential multiplicity with respect to instances of other devices that may be included in the network 30 and that may practice example embodiments. The communications devices of the system may be able to communicate with network devices or with each other via the network 30. In some cases, the network devices with which the communication devices of the system communicate may include a service platform 40. In an example embodiment, the mobile terminal 10 (and/or the second communication device 20) is enabled to communicate with the service platform 40 to provide, request and/or receive information.

In some embodiments, not all systems that employ embodiments of the present invention may comprise all the devices illustrated and/or described herein. For example, while an example embodiment will be described herein in which a map service is provided from a network device (e.g., the service platform 40) and accessed at the mobile terminal 10, some embodiments may exclude the service platform 40 and network 30 altogether and simply be practiced on a single device (e.g., the mobile terminal 10 or the second communication device 20) in a stand alone mode.

While several embodiments of the mobile terminal 10 may be illustrated and hereinafter described for purposes of example, other types of mobile terminals, such as portable digital assistants (PDAs), pagers, mobile televisions, mobile telephones, gaming devices, laptop computers, cameras, camera phones, video recorders, audio/video player, radio, GPS devices, navigation devices, or any combination of the aforementioned, and other types of voice and text communications systems, can readily employ embodiments of the present invention. Furthermore, devices that are not mobile may also readily employ embodiments of the present invention. As such, for example, the second communication device 20 may represent an example of a fixed electronic device that may employ an example embodiment. For example, the second communication device 20 may be a personal computer (PC) or other terminal having a touch display.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be capable of communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the mobile terminal 10 and the second communication device 20 via the network 30. By directly or indirectly connecting the mobile terminal 10, the second communication device 20 and other devices to the network 30, the mobile terminal 10 and the second communication device 20 may be enabled to communicate with the other devices (or each other), for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 40 may be a device or node such as a server or other processing element. The service platform 40 may have any number of functions or associations with various services. As such, for example, the service platform 40 may be a platform such as a dedicated server (or server bank) associated with a particular information source or service (e.g., a mapping service, a routing service and/or a navigation service), or the service platform 40 may be a backend server associated with one or more other functions or services. As such, the service platform 40 represents a potential host for a plurality of different services or information sources. In some embodiments, the functionality of the service platform 40 is provided by hardware and/or software components configured to operate in accordance with known techniques for the provision of information to users of communication devices. However, at least some of the functionality provided by the service platform 40 is information provided in accordance with example embodiments of the present invention.

In an example embodiment, the service platform 40 (or the mobile terminal 10 or second communication device 20 in embodiments where the network 30 is not employed) may include service provision circuitry 42 that hosts a service application 44 as described in greater detail below. The mobile terminal 10, the second communication device 20 and other devices may each represent sources for information that may be provided to the service platform 40 as well as potential recipients for information provided from the service platform 40. In some embodiments of the present invention, the service application 44 may be associated with a mapping service capable of providing accurate maps (e.g., road maps).

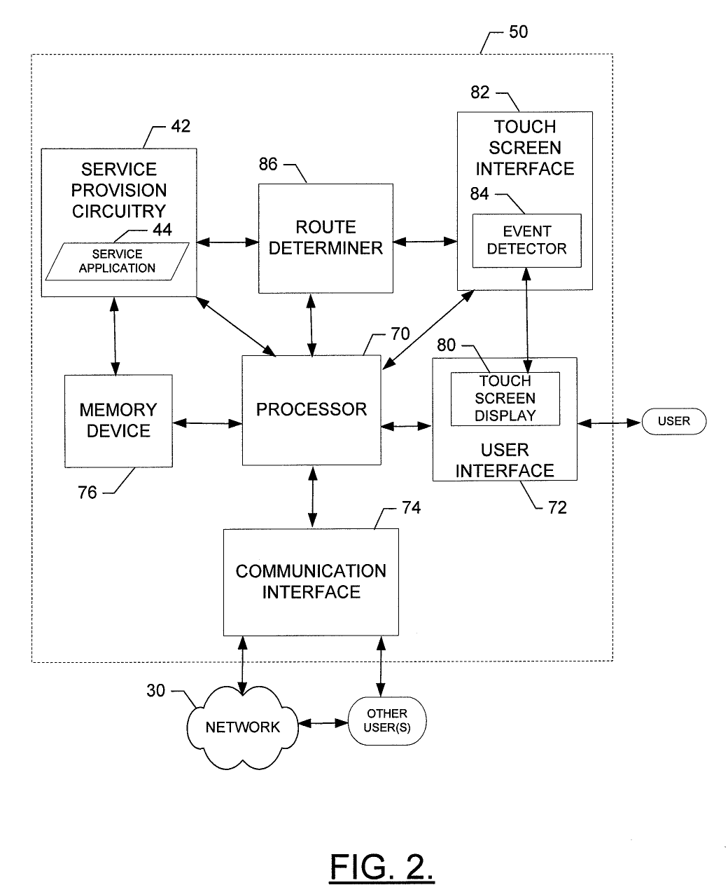

FIG. 2 illustrates a schematic block diagram of an apparatus for providing touch based routing services according to an example embodiment of the present invention. An example embodiment of the invention will now be described with reference to FIG. 2, in which certain elements of an apparatus 50 for providing touch based routing services are displayed. The apparatus 50 of FIG. 2 may be employed, for example, on the service platform 40. However, the apparatus 50 may alternatively be embodied at a variety of other devices, both mobile and fixed (such as, for example, any of the devices listed above). In some cases, embodiments may be employed on either one or a combination of devices. Accordingly, some embodiments of the present invention may be embodied wholly at a single device (e.g., the service platform 40, the mobile terminal 10 or the second communication device 20), by a plurality of devices in a distributed fashion or by devices in a client/server relationship (e.g., the mobile terminal 10 and the service platform 40). Furthermore, it should be noted that the devices or elements described below may not be mandatory and thus some may be omitted in certain embodiments.

Referring now to FIG. 2, an apparatus for providing touch based routing services is provided. The apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., the mobile terminal 10 or a network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the user interface 72 may include a touch screen display 80. The touch screen display 80 may be embodied as any known multi-touch screen display. Thus, for example, the touch screen display 80 could be configured to enable touch recognition by any suitable technique, such as resistive, capacitive, infrared, strain gauge, surface wave, optical imaging, dispersive signal technology, acoustic pulse recognition, etc. techniques.

In some embodiments, the processor 70 may be embodied as, include or otherwise control a touch screen interface 82 as well. The touch screen interface 82 may be in communication with the touch screen display 80 to receive an indication of a touch event at the touch screen display 82 and to generate a response to the indication in certain situations. In some cases, the touch screen interface 82 may be configured to modify display properties of the touch screen display 80 with respect to the display of route data generated responsive to touch inputs. In an example embodiment, the touch screen interface 82 may include an event detector 84. The event detector 84 may be in communication with the touch screen display 80 to determine the occurrence of a touch event associated with a particular operation based on each input or indication of an input received at the event detector 84. In this regard, for example, the event detector 84 may be configured to receive an indication of a touch event and may also receive an input or otherwise be aware of other touch events occurring simultaneously with or temporally proximately to a current touch event. Accordingly, if the current touch event is received simultaneous with, prior to or subsequent to another touch event, the various touch events may be recognized and identified for route determination or manipulation as described in greater detail below. As such, the touch screen display 80 may be configured to provide characteristics of a detection of a touch event such as information indicative of timing (order of touch events, length of a touch event, etc.) and type or classification of a touch event (e.g., based on the pressure exerted, the size of pointing device, the location of the touch event), among other things, to the event detector 84 to enable the event detector 84 to classify touch events for use in route determination or modification as described herein. As such, characteristics corresponding to a length of time for which an object touches the touch screen display 80 being above a particular threshold or the pressure applied in a touch event relative to a threshold may be designated to correspond to specific classifications of touch events.

In an example embodiment, the processor 70 may be embodied as, include or otherwise control service provision circuitry 42. In this regard, for example, the service provision circuitry 42 includes structure for executing the service application 44. The service application 44 may be an application including instructions for execution of various functions in association with example embodiments of the present invention. In an example embodiment, the service application 44 includes or otherwise communicates with applications and/or circuitry for providing a mapping service. The mapping service may further include routing services and/or directory or look-up services related to a particular service point (e.g., business, venue, party or event location, address, site or other entity related to a particular geographic location and/or event). As such, the service application 44 may provide maps (e.g., via map data retrieved from the memory device 76 or from the network 30) to a remote or local user of or subscriber to the mapping service associated with the service application 44. In some cases, route guidance to specific locations on the map may be further provided and/or detailed information (e.g., address, phone number, email address, hours of operation, descriptions of services, and/or the like) about points of interest or businesses may be provided by the service application. Accordingly, the service provision circuitry 42 and the service application 44 may provide basic functionality for a mapping service (and/or guidance and directory services).

However, according to an example embodiment, the service provision circuitry 42 and/or the service application 44 include and/or are in communication with additional devices or modules configured to enhance the basic mapping service to enable route calculation and updating as described herein. In this regard, for example, the processor 70 (e.g., via a route determiner 86) may be configured to enable touch based selection of route parameters that may be dynamically adjustable as will be described in greater detail below. Additionally, for example, the service provision circuitry 42 and the service application 44 may provide an ability to select different regions for which maps may be presented and provide zoom and orientation options for tailoring the map view to the user's preferences. In some cases, the service provision circuitry 42 and the service application 44 may also provide pinch zoom (in or out) functionality and/or pivot rotation functionality (e.g., placing a finger in a selected location to fix a pivot point and then moving another finger in an arc relative to the pivot point to define an axis for rotation of the map view around the pivot point).

In an exemplary embodiment, the processor 70 may be embodied as, include or otherwise control the route determiner 86 and the event detector 84. As such, in some embodiments, the processor 70 may be said to cause, direct or control the execution or occurrence of the various functions attributed to the route determiner 86 (and/or the event detector) as described herein. The route determiner 86 and the event detector 84 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the route determiner 86 and the event detector 84, respectively, as described herein. Thus, in examples in which software is employed, a device or circuitry (e.g., the processor 70 in one example) executing the software forms the structure associated with such means.

The route determiner 86 may be configured to generate route data on a map provided by the service application 44. Moreover, the route determiner 86 may be configured to receive indications of touch events from the event detector 84 and associate respective touch events with corresponding points on a route (e.g., start point, destination point and waypoints) and generate route data based on the corresponding points. In an example embodiment, a first touch event may be received to define a start point for a route. As such, the start point for a route may be independent of the current location of the user. However, if the user's position is visible on a map view provided on the touch screen display 80, the user's current position may be indicated on the map view. In such cases, the user may, of course, touch the user's position to define the user's position as the start point for a route. However, there is no limitation that necessarily requires that the start point for a route must match the user's current position.

After the user defines the start point as being associated with a first touch event, the user may then identify a destination point by indicating a position corresponding to the map location associated with a second touch event. In response to definition of a start point and a destination point, the route determiner 86 may be configured to generate a route. The route generated may be selected based on user selected or predetermined (e.g., via preferences or other settings) criteria such as the shortest or fastest route. In some cases, the first touch event and the second touch event may be received nearly simultaneously. In such situations, the route determiner 86 may still be enabled to define a generic route between the two points based on the predetermined criteria. However, an indication may be provided as to the ambiguity with respect to start and destination points.

After the route is initially generated and route data corresponding to the generated route is displayed on the touch screen display 80, the user may select one or more waypoints through which it is desirable for the route to pass. Accordingly, the event detector 84 may detect one or more corresponding subsequent touch events that may each be associated with corresponding waypoints. The route determiner 86 may be configured to then modify the route to generate an updated route that passes through each waypoint defined. In an example embodiment, each touch event made while holding the first two fingers or other pointing objects in place (e.g., the fingers that define the start point and destination point) may be interpreted as a corresponding different waypoint. In some embodiments, the route determiner 86 may determine an updated route and display the updated route immediately after it is determined. However, in other embodiments, a delay may be inserted in case other waypoints are also selected in order to prevent the usage of processing resources to generate an updated route that will only be superseded quickly thereafter.

In some embodiments, all touch events associated with points on route may be required to be active (e.g., the finger initiating a corresponding touch event may be required to actually be touching the touch screen display 80) simultaneously in order to be considered. For example, the first two touch events may be held active and the route may be displayed. A third touch event may then define a first waypoint and the route may be updated accordingly. If the finger defining the third touch event is moved to another location, the first waypoint may be deleted and the other location may define a second waypoint that would then be the only waypoint displayed for the route. If the finger associated with the first touch event is removed, the start point may be deleted and the second waypoint may be updated to correspond to the start point and a route from what was the second waypoint to the destination point may be displayed. Likewise, if instead the finger associated with the second touch event is removed, the destination point may be deleted and the second waypoint in that case may be updated to correspond to the destination point and a route from the start point to what was the second waypoint may be displayed. As such, in some examples, when a touch event is ended, the information associated with the corresponding touch event may be deleted and ignored.

In an alternative embodiment, some or all past touch information may be saved according to user preferences or settings. In some instances, touch event classification may determine whether or not touch event related information is saved. For example, in some cases the user may define multiple classes of touch event (e.g., a normal touch event associated with typical pressure exerted on the touch screen display 80 and a strong or hard touch event associated with exerting more pressure on the touch screen display 80). In such cases, one class of touch event may be associated with instant deletion when touch events are ended (e.g., the normal touch event) and the other class of touch event may be associated with an intent to store the corresponding location associated with the touch event (e.g., a strong touch event). Thus, for example, the user may use strong touch events to define start and destination points for a route and remove the fingers from the touch screen display 80, but still have the route between the start and destination points displayed. The user may then use fingers to define various waypoints to view an updated route or routes based on the waypoints defined. As yet another alternative, the user may be able to touch a point and then select separately a function key, button or other menu option to store the corresponding location. Thus, for example, a location such as a home address, a friend's address, a commonly visited location, or other locations of interest may have corresponding position information associated therewith stored long term. In some cases, information stored in association with various points may be stored in the memory device 76.

In some embodiments, the route determiner 86 may be configured to display additional information and conduct additional functions with respect to route data. In some cases, the additional information and/or functionality may be provided on the basis of a mode of operation defined for the route determiner 86. As such, for example, during normal operation, the route determiner 86 may indicate route data and modify the route data as indicated above. However, in other modes, corresponding additional information and/or functions may be made available. As an example, in addition to providing a visual indication of the route (e.g., by highlighting the route, indicating an arrow corresponding to the route or otherwise distinguishing a pathway for travel as an overlay or addition to the map view) the route determiner 86 may display a route parameter window to provide a text description of route parameters (e.g., any or all of starting address, destination address, waypoint address, distance information, walking or driving time, and/or the like).

In an example embodiment, after a touch event is detected by the event detector 84, the service application 44 may interact with the route determiner 86 to provide information indicative of an address associated with the touch event. In cases where there is some ambiguity, a listing of potential address options may be presented to the user for user verification. For example, if there is street level ambiguity, each nearby street (perhaps in order of closeness to the position of the touch event) may be listed to enable the user to select the desired street. Meanwhile, if there is address number ambiguity, each nearby address number (perhaps again in order of closeness to the position of the touch event) may be listed to enable the user to select the desired address number. Address verification to resolve ambiguities may be practiced for each touch event, or only for certain touch events (e.g., the start point and the destination point) dependent upon user preferences or other predetermined settings.

In some cases, such as where an address corresponding to a touch event is associated with a particular venue, establishment, friend, colleague or other entity known to the user or publicly known, information about the corresponding entity may be presented in a supplemental information window that may appear in connection with a particular address. Thus, for example, if an address corresponds to the home or work place of a friend from the user's contact list, a picture of the corresponding friend (and perhaps also contact information) may appear in the supplemental information window. In some cases, the user may select the contact information to contact the corresponding friend by, for example, calling the number listed or sending a message to the address listed. Likewise, if an address corresponds to a restaurant or a famous site, information about the restaurant (e.g., picture, contact information, links to ratings, links to the menu, etc.) or the famous site (e.g., picture, contact information, links to encyclopedia articles or other related literature, hours of operation, etc.) may be provided. Some of the supplemental information (e.g., links and contact information) may be selectable, as described above, to enable the user to contact entities or retrieve additional information. In some cases, rather than selecting information from the supplemental information window, the user may implement certain functions by re-pressing or pressing a location of a touch event harder. Thus, for example, when a touch event is recognized, supplemental information may be presented. If the user wishes to access the supplemental information (e.g., call a contact), the user may simply press the location of the touch event harder and the access may be granted (or the call may be placed).

In some embodiments, a public transportation mode may be supported. In the public transportation mode, the route determiner 86 may access public transportation route information and display route data based on public transportation options that may be suitable for transit through the defined route points that are selected by the touch events. In some cases, the user may specify a preference order for different modes of transportation and the route determiner 86 may be configured to generate a route that passes through the defined route points based on both the available public transportation options and the preference order listed. Other modes of operation such as a gaming mode in which quiz questions are asked of the user and answers to the quiz questions are provided by selecting map locations are also possible.

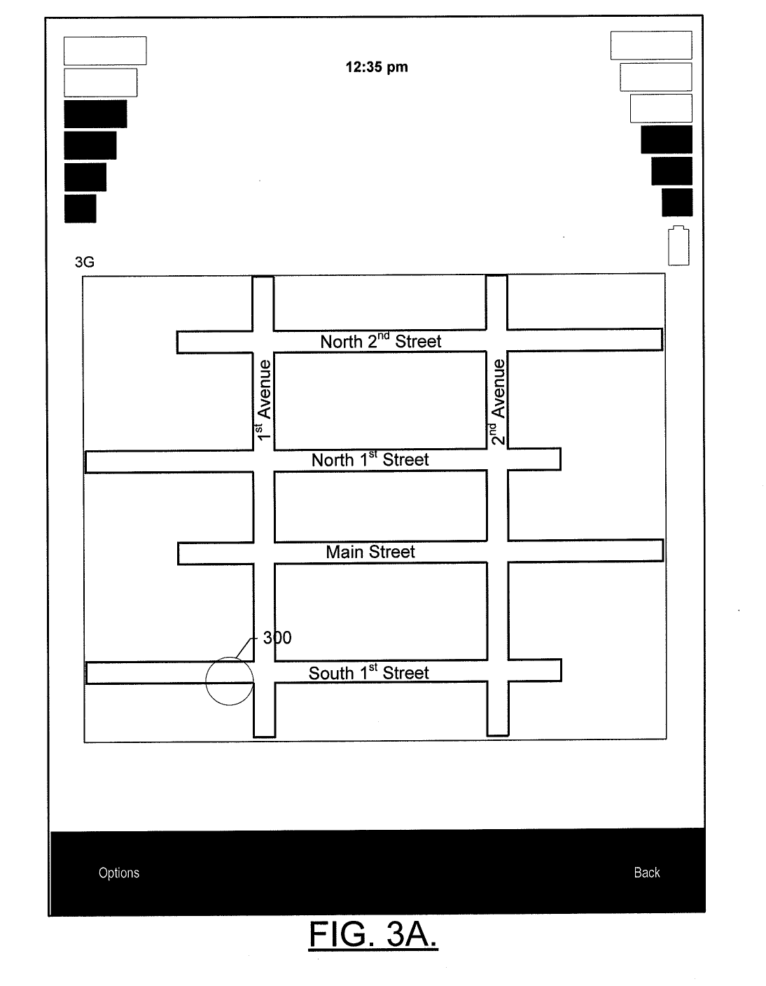

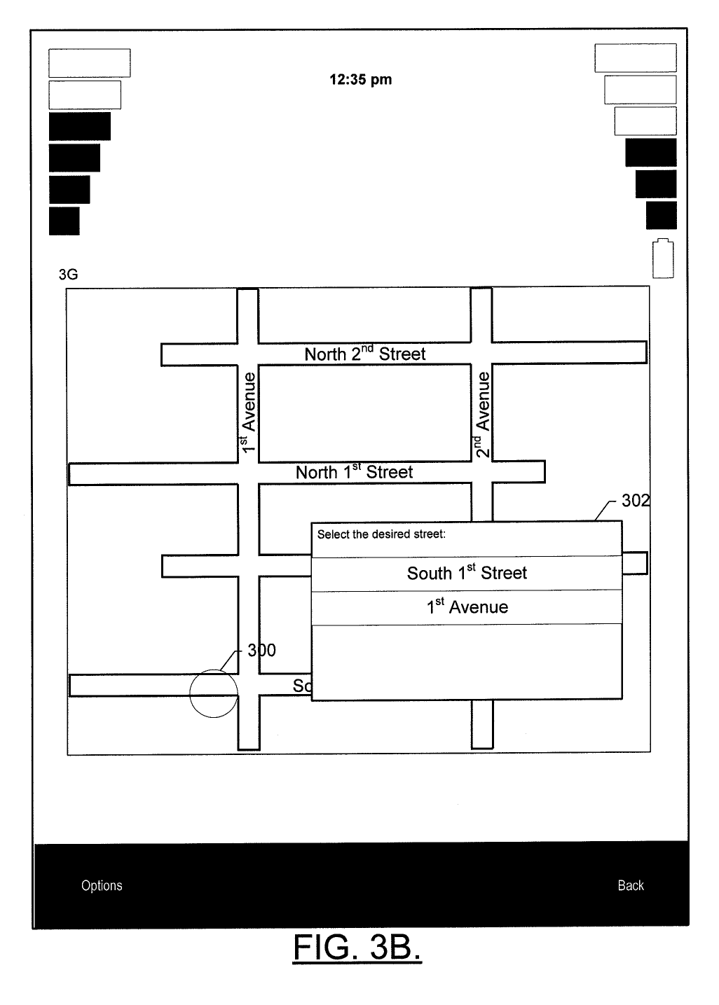

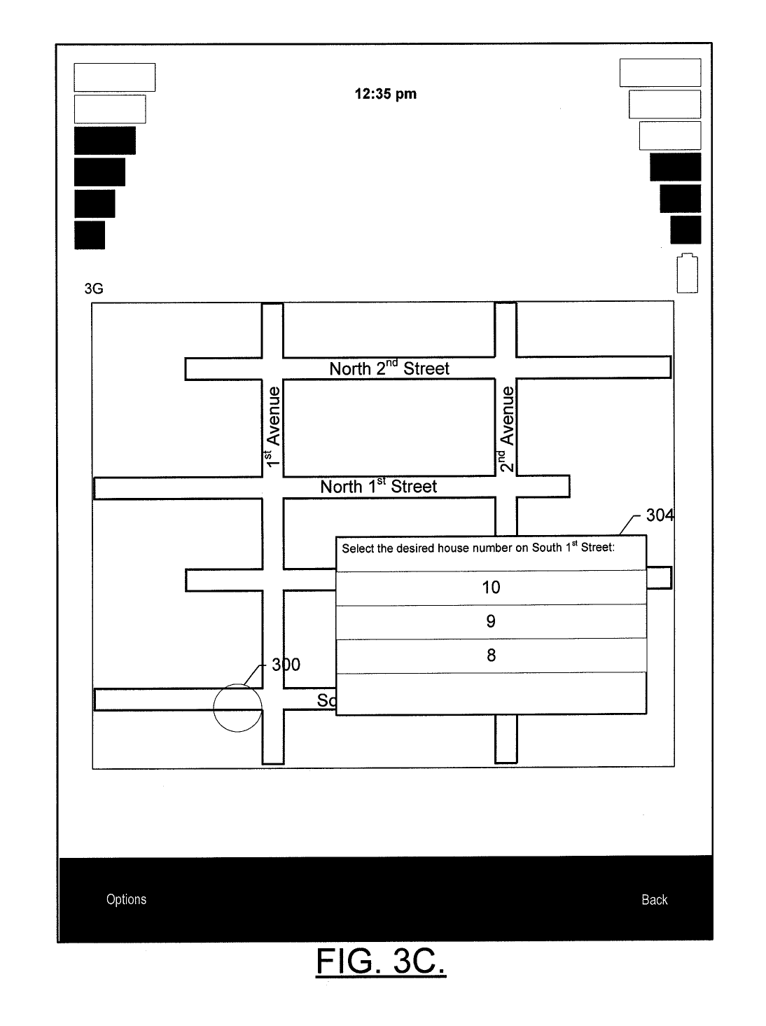

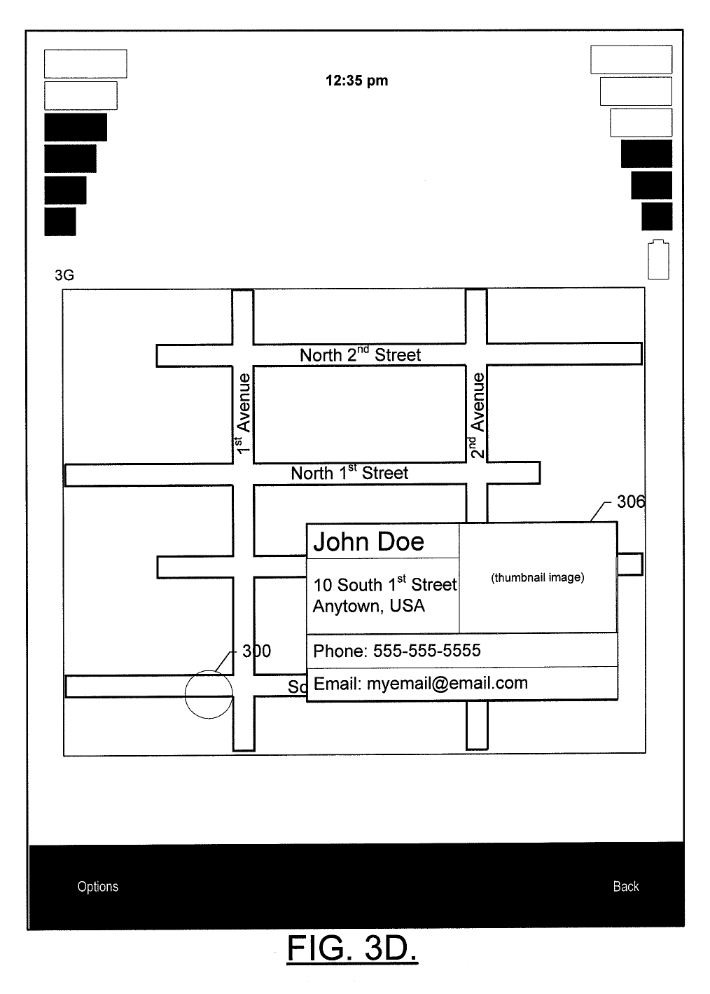

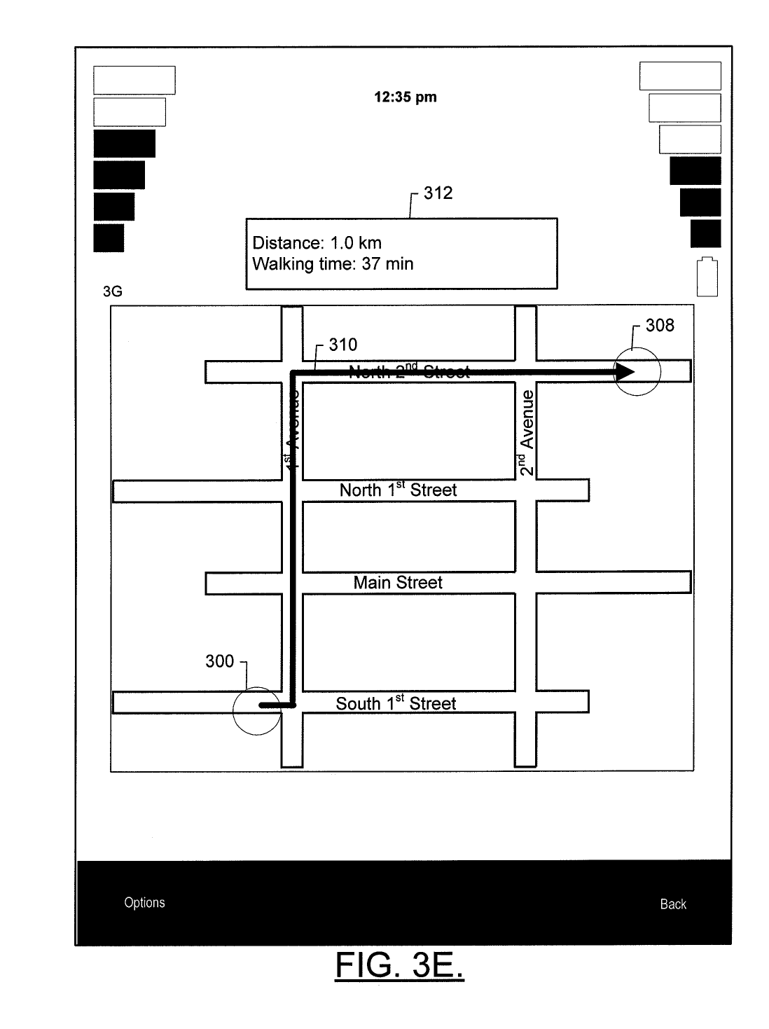

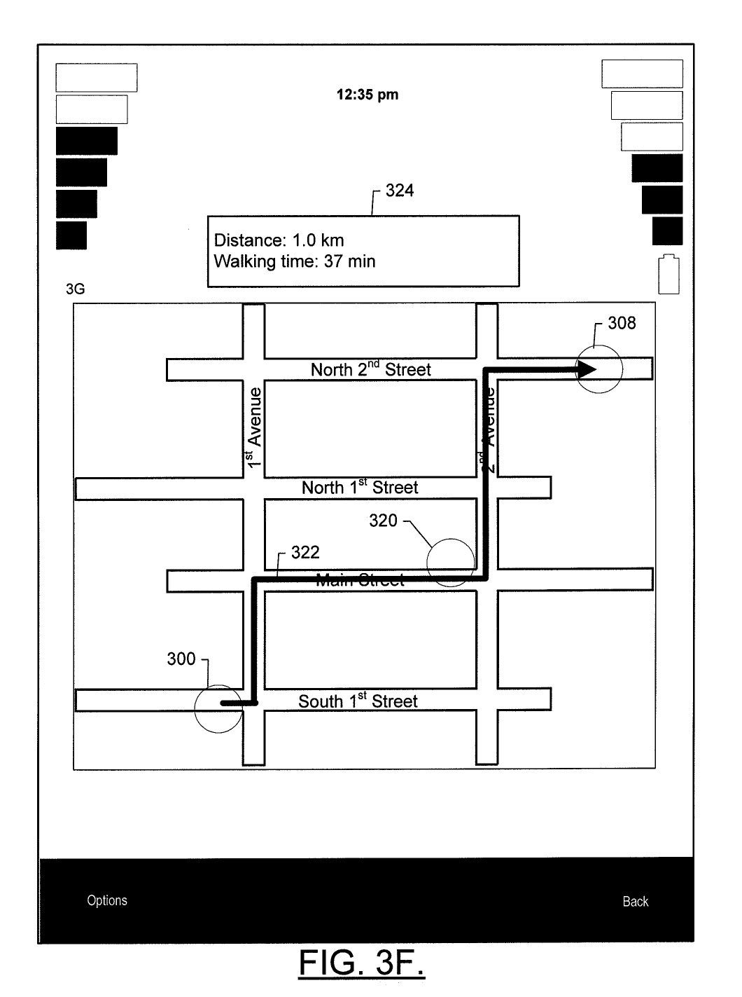

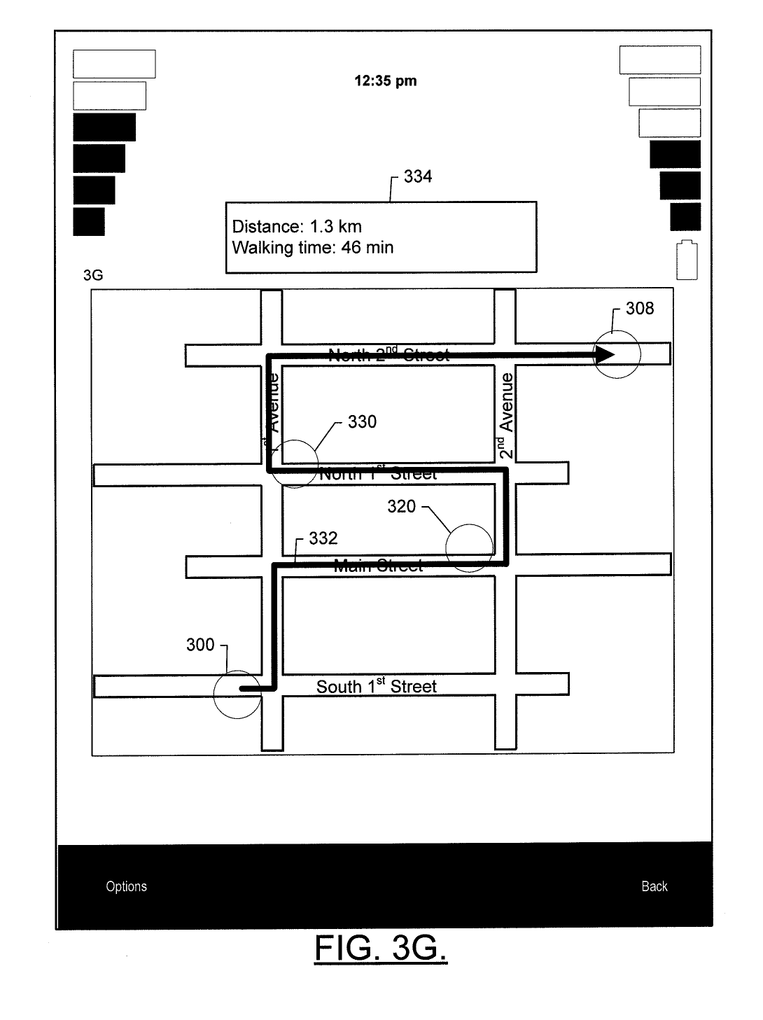

FIG. 3, which includes FIGS. 3A to 3G, illustrates an example of a map display during various stages of operation according to an example embodiment of the present invention. In this regard, as shown in FIG. 3A, a map may be displayed showing various map features. Although the example map displayed only shows roads, intersections and road names, other features such as points of interest, topographical features, route information, navigational aids, and/or the like may also be included. As such, the map of FIG. 3A should be understood to merely represent a very simple map to provide a basis for explanation of a basic example. In this example, a first touch event 300 may be experienced at a portion of the map corresponding to the highlighted region indicated by a circle in FIG. 3A. FIG. 3B shows an optional embodiment in which, as described above, address ambiguity may be resolved. In this regard, the first touch event 300 is near an intersection between two streets. Thus, information window 302 is presented to list the two street options from which the user may select. As described above, address number ambiguity may then be resolved with via selection of a house number from a list shown in a second information window 304 as indicated in FIG. 3C. Moreover, in some cases, if a location associated with a touch event corresponds to a particular contact, venue or other entity, a supplemental information window 306 may be presented. In FIG. 3D, an example is presented in which the address associated with the first touch event 300 corresponds to a particular contact. The supplemental information window 306 may include address information for the contact, a thumbnail image of the contact, email address, phone number, and/or the like. In some cases, selection of contact information from the supplemental information window 306 may be performed to initiate, for example, calling or emailing the corresponding contact.

As shown in FIG. 3E, in response to detection of a second touch event 308, a route 310 may be displayed by highlighting a path from the start point defined by the first touch event 300 to the destination point defined by the second touch event 308. The route 310 may be determined based on predefined settings (e.g., fastest, shortest, and/or the like). In some cases, address ambiguity may also be resolved for the second touch event 308, as described above. However, user preferences or other settings may determine whether address ambiguity resolution is practiced in a particular embodiment. In an example embodiment, in addition to presenting the route 310 on the map itself, a route information window 312 may be presented. The route information window 312 may present information indicative of the distance between the start point and the destination point, travel time between the start point and the destination point, and/or the like.

FIG. 3F shows a further development of an example case in which, for example, a third finger may contact the touch screen display 80 in order to define a third touch event 320. In this example embodiment, while holding the first touch event 300 and the second touch event 308, the user may initiate the third touch event 320 (with or without address ambiguity resolution) to define a waypoint. In an example embodiment, in response to detection of the third touch event 320 (e.g., by the event detector 84), the route determiner 86 calculates a modified route 322 between the start point and the destination point, but passing also through the waypoint defined by the third touch event 320. The modified route 322 may then be presented on the touch screen display 80 along with an updated route information window 324.

As shown in FIG. 3G, still further fingers may be used to initiate additional touch events and therefore corresponding additional waypoints. For example, a fourth touch event 330 may be detected at another location and the route determiner 86 may be configured to generate an additional modified route 332 passing also through the waypoint defined by the fourth touch event 330. Notably, since the fourth touch event 330 of this example is initiated while the third touch event 320 is maintained, the fourth touch event 330 is interpreted as a second waypoint. However, if the third touch event 320 were replaced by the fourth touch event 330, then the fourth touch event 330 would instead define a new waypoint to replace the waypoint that was associated with the third touch event 320. A modified route information window 334 may also be presented for the current route.

In some embodiments, a finger defining the third touch event 320 may be gradually slid across the touch screen display 80 and the route determiner 86 may be configured to continuously or periodically update the map display by generating updated routes for the changing position of the user's finger. When the user moves two, three or more fingers over the touch screen display 80 (e.g., over the map displayed on the touch screen display 80), some embodiments may provide that the route, time, distance and/or other like descriptors or characteristics relating to the route are correspondingly displayed. In some embodiments, after a route is displayed, the route may be stored (and perhaps also displayed) for a period of time even after removal of the user's fingers. User preferences or settings may determine how long a route is displayed after the touch events that defined the route have ended.

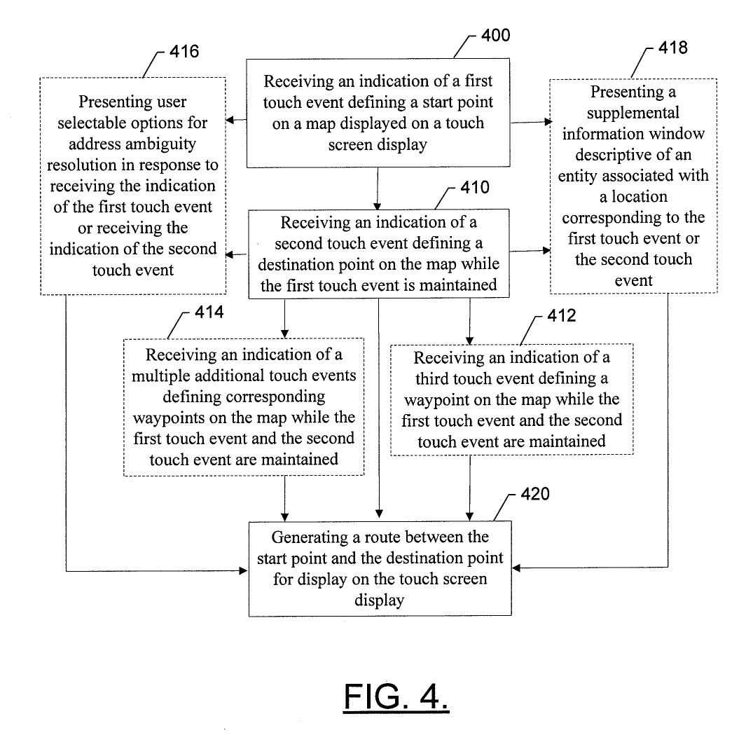

FIG. 4 is a flowchart of a method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 4, may include receiving an indication of a first touch event defining a start point on a map displayed on a touch screen display at operation 400, receiving an indication of a second touch event defining a destination point on the map while the first touch event is maintained at operation 410, and generating a route between the start point and the destination point for display on the touch screen display at operation 420.

In some embodiments, certain ones of the operations above may be modified or further amplified as described below. Moreover, in some embodiments additional optional operations may also be included (an example of which is shown in dashed lines in FIG. 4). It should be appreciated that each of the modifications, optional additions or amplifications below may be included with the operations above either alone or in combination with any others among the features described herein. In this regard, for example, the method may further include receiving an indication of a third touch event defining a waypoint on the map while the first touch event and the second touch event are maintained at operation 412. In such situations, generating the route may include generating the route between the start point and the destination point to pass through the waypoint. In some embodiments, at least one of the first touch event, the second touch event or the third touch event may be enabled to dynamically move, and generating the route may include updating the route substantially in real time based on movement of the at least one of the first touch event, the second touch event or the third touch event. In an example embodiment, the method may further include receiving an indication of a multiple additional touch events defining corresponding waypoints on the map while the first touch event and the second touch event are maintained at operation 414. In such examples, generating the route may include generating the route between the start point and the destination point to pass through the corresponding waypoints. In another example embodiment, the method may further include presenting user selectable options for address ambiguity resolution in response to receiving the indication of the first touch event or receiving the indication of the second touch event at operation 416. In some embodiments, the method may further include presenting a supplemental information window descriptive of an entity associated with a location corresponding to the first touch event or the second touch event at operation 418. In some cases, generating the route further may further include generating a route information window providing information descriptive of the route.

In an example embodiment, an apparatus for performing the method of FIG. 4 above may comprise a processor (e.g., the processor 70) configured to perform some or each of the operations (400-420) described above. The processor may, for example, be configured to perform the operations (400-420) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-420 may comprise, for example, the processor 70, the route determiner 86, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a first touch event defining a start point on a map displayed on a touch screen display;
receiving an indication of a second touch event defining a destination point on the map while the first touch event is maintained; and
generating a route between the start point and the destination point for display on the touch screen display.

2. The method of claim 1, further comprising receiving an indication of a third touch event defining a waypoint on the map while the first touch event and the second touch event are maintained, wherein generating the route comprises generating the route between the start point and the destination point to pass through the waypoint.

3. The method of claim 2, wherein at least one of the first touch event, the second touch event or the third touch event is enabled to dynamically move, and wherein generating the route comprises updating the route substantially in real time based on movement of the at least one of the first touch event, the second touch event or the third touch event.

4. The method of claim 1, further comprising receiving an indication of a multiple additional touch events defining corresponding waypoints on the map while the first touch event and the second touch event are maintained, wherein generating the route comprises generating the route between the start point and the destination point to pass through the corresponding waypoints.

5. The method of claim 1, further comprising presenting user selectable options for address ambiguity resolution in response to receiving the indication of the first touch event or receiving the indication of the second touch event.

6. The method of claim 1, further comprising presenting a supplemental information window descriptive of an entity associated with a location corresponding to the first touch event or the second touch event.

7. The method of claim 1, wherein generating the route further comprises generating a route information window providing information descriptive of the route.

8. A computer program product comprising at least one computer-readable storage medium having computer-executable program code instructions stored therein, the computer-executable program code instruction comprising:
program code instructions for receiving an indication of a first touch event defining a start point on a map displayed on a touch screen display;
program code instructions for receiving an indication of a second touch event defining a destination point on the map while the first touch event is maintained; and
program code instructions for generating a route between the start point and the destination point for display on the touch screen display.

9. The computer program product of claim 8, further comprising program code instructions for receiving an indication of a third touch event defining a waypoint on the map while the first touch event and the second touch event are maintained, wherein program code instructions for generating the route include instructions for generating the route between the start point and the destination point to pass through the waypoint.

10. The computer program product of claim 9, wherein at least one of the first touch event, the second touch event or the third touch event is enabled to dynamically move, and wherein program code instructions for generating the route include instructions for updating the route substantially in real time based on movement of the at least one of the first touch event, the second touch event or the third touch event.

11. The computer program product of claim 8, further comprising program code instructions for receiving an indication of a multiple additional touch events defining corresponding waypoints on the map while the first touch event and the second touch event are maintained, wherein program code instructions for generating the route include instructions for generating the route between the start point and the destination point to pass through the corresponding waypoints.

12. The computer program product of claim 8, further comprising program code instructions for presenting user selectable options for address ambiguity resolution in response to receiving the indication of the first touch event or receiving the indication of the second touch event.

13. The computer program product of claim 8, further comprising program code instructions for presenting a supplemental information window descriptive of an entity associated with a location corresponding to the first touch event or the second touch event.

14. An apparatus comprising at least one processor and at least one memory including computer program code, the at least one memory and the computer program code configured to, with the at least one processor, cause the apparatus at least to perform:
receiving an indication of a first touch event defining a start point on a map displayed on a touch screen display;
receiving an indication of a second touch event defining a destination point on the map while the first touch event is maintained; and
generating a route between the start point and the destination point for display on the touch screen display.

15. The apparatus of claim 14, wherein the at least one memory and the computer program code are further configured to, with the at least one processor, cause the apparatus to receive an indication of a third touch event defining a waypoint on the map while the first touch event and the second touch event are maintained, wherein generating the route comprises generating the route between the start point and the destination point to pass through the waypoint.

16. The apparatus of claim 15, wherein at least one of the first touch event, the second touch event or the third touch event is enabled to dynamically move, and wherein generating the route comprises updating the route substantially in real time based on movement of the at least one of the first touch event, the second touch event or the third touch event.

17. The apparatus of claim 14, wherein the at least one memory and the computer program code are further configured to, with the at least one processor, cause the apparatus to receive an indication of a multiple additional touch events defining corresponding waypoints on the map while the first touch event and the second touch event are maintained, wherein generating the route comprises generating the route between the start point and the destination point to pass through the corresponding waypoints.

18. The apparatus of claim 14, wherein the at least one memory and the computer program code are further configured to, with the at least one processor, cause the apparatus to present user selectable options for address ambiguity resolution in response to receiving the indication of the first touch event or receiving the indication of the second touch event.

19. The apparatus of claim 14, wherein the at least one memory and the computer program code are further configured to, with the at least one processor, cause the apparatus to present a supplemental information window descriptive of an entity associated with a location corresponding to the first touch event or the second touch event.

20. The apparatus of claim 14, wherein generating the route further comprises generating a route information window providing information descriptive of the route.
